(19) United States
(12) Patent Application Publication
(10) Pub. No.: US 2021/0357970 A1
(43) Pub. Date: Nov. 18, 2021

(54) SYSTEMS AND METHODS FOR DIGITAL MESSAGING

(71) Applicant: Blake Putman, Caro, MI (US)

(72) Inventor: Blake Putman, Caro, MI (US)

(21) Appl. No.: 17/317,400

(22) Filed: May 11, 2021

Related U.S. Application Data
(60) Provisional application No. 63/024,832, filed on May 14, 2020.

(51) Int. Cl. G06Q 30/02; H04L 12/58; G06F 40/20; G06N 20/00

(52) U.S. Cl. CPC G06Q 30/0236; G06Q 30/0277; G06N 20/00; H04L 51/16; G06F 40/20; H04L 51/08

(57) ABSTRACT

A method for embedding information in a digital message includes: receiving a digital message from a computing device; identifying at least one keyword associated with the digital message; identifying, using the at least one keyword, an attachment item corresponding to the at least one keyword; embedding the attachment item in a conversation thread corresponding to the digital message; and updating a table of a database to indicate the digital message and the attachment item.

### CROSS-REFERENCES TO RELATED APPLICATIONS

This patent application claims priority to U.S. Provisional Patent Application Ser. No. 63/024,832, filed May 14, 2020 which is incorporated herein by reference in its entirety.

### TECHNICAL FIELD

This disclosure relates to digital messaging and in particular to systems and methods for appending information during transmission of a digital message.

### BACKGROUND OF THE INVENTION

Increasingly, technology users, such as smart phone users, tablet computer users, laptop computer users, and the like, rely on various digital message platforms to communicate with other users. For example, typical technology users utilize short message service messaging technology, text message technology, e-mail technology, dedicated messaging service technology, other suitable messaging technology, or a combination thereof. Such messaging technologies may allow technology users to communicate relatively quickly with other users, compared to traditional non-digital messaging technology, such as postal mail and the like.

### SUMMARY OF THE INVENTION

This disclosure relates generally to digital messaging.

An aspect of the disclosed embodiments includes a method for embedding information in a digital message. The method includes receiving one or more user characteristics associated with a user of a corresponding computing device. The method also includes identifying at least one attachment item based on the one or more user characteristics and identifying at least one digital message setting corresponding to the user. The method also includes determining whether to embed the at least one attachment item based on the at least one digital message setting. The method also includes, in response to a determination to embed the at least one attachment item: generating a digital message including the at least one attachment item; determining a reward corresponding to the at least one attachment item; and updating a user account associated with the user based on the reward.

Another aspect of the disclosed embodiments includes a system for embedding information in a digital message. The system includes a processor and a memory. The memory includes instructions that, when executed by the processor, cause the processor to: receive one or more user characteristics associated with a user of a corresponding computing device; identify at least one attachment item based on the one or more user characteristics; identify at least one digital message setting corresponding to the user; determine whether to embed the at least one attachment item based on the at least one digital message setting; and, in response to a determination to embed the at least one attachment item: generate a digital message including the at least one attachment item; determine a reward corresponding to the at least one attachment item; and update a user account associated with the user based on the reward.

Another aspect of the disclosed embodiments includes a method for embedding information in a digital message. The method includes: receiving a digital message from a computing device; identifying at least one keyword associated with the digital message; identifying, using the at least one keyword, an attachment item corresponding to the at least one keyword; embedding the attachment item in a conversation thread corresponding to the digital message; and updating a table of a database to indicate the digital message and the attachment item.

Another aspect of the disclosed embodiments includes a system for embedding information in a digital message. The system includes a processor and a memory that includes instructions that, when executed by the processor, cause the processor to: receive a digital message from a computing device; identify at least one keyword associated with the digital message; identify, using the at least one keyword, an attachment item corresponding to the at least one keyword; embed the attachment item in a conversation thread corresponding to the digital message; and update a table of a database to indicate the digital message and the attachment item.

Another aspect of the disclosed embodiments includes a computing device that includes a processor; and a memory that includes instructions that, when executed by the processor, cause the processor to: receive one or more user characteristics associated with a user of a corresponding computing device; identify at least one attachment item based on the one or more user characteristics; identify at least one digital message setting corresponding to the user; determine whether to embed the at least one attachment item based on the at least one digital message setting; and, in response to a determination to embed the at least one attachment item: generate a digital message including the at least one attachment item; determine a reward corresponding to the at least one attachment item; and update a user account associated with the user based on the reward.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a message delivery system according to the principles of the present disclosure.

FIG. 1B generally illustrated a computing device according to the principles of the present disclosure.

FIG. 2 generally illustrates message delivery display according to the principles of the present disclosure.

FIG. 3 is a flow diagram generally illustrating a message delivery method according to the principles of the present disclosure.

FIG. 4 generally illustrates a message delivery system according to the principles of the present disclosure.

FIG. 5 is a flow diagram generally illustrating an alternative message delivery method according to the principles of the present disclosure.

FIG. 6 is a flow diagram generally illustrating an alternative message delivery method according to the principles of the present disclosure.

FIG. 7 is a flow diagram generally illustrating an alternative message delivery method according to the principles of the present disclosure.

FIG. 8 is a flow diagram generally illustrating an alternative message delivery method according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, technology users, such as smart phone users, tablet computer users, laptop computer users, and the like, are increasingly relying on various digital message platforms to communicate with other users. For example, typical technology users utilize short message service messaging technology, text message technology, e-mail technology, dedicated messaging service technology, other suitable messaging technology, or a combination thereof. Such messaging technologies may allow technology users to communicate relatively quickly with other users, compared to traditional non-digital messaging technology, such as postal mail and the like.

As an increasing number of technology users (e.g. herein after referred to as a user or users) continue to rely on digital messaging as a means for communication with other users, there may be a need to provide enhanced features for digital messaging services. Accordingly, systems and methods, such as those described herein, may be configured to embed attachment items during transmission of a digital message.

In some embodiments, the systems and methods described herein may be configured to allow a sending user generate and send a digital message, such as a text message or other suitable digital message, to a receiving user with a small advertisement attached to the digital message. The systems and methods described herein may be configured to allow the sending user to attach one or more attachment items (e.g., such as the small advertisement) to a digital message at any given time (e.g., every time the sending user generates a digital message, every time the sending user generates a digital message indented for a particular receiving user, and the like). The systems and methods described herein may be configured to identify a reward associated with the attachment of one or more attachment items and may provide the reward (e.g., such as a small gratuity) to an account associated with the sending user.

In some embodiments, the systems and methods described herein may be configured to receive one or more user characteristics associated with a user of a corresponding computing device. The user characteristics may include a user choice preference, a user name, a user age, a user gender, a user demography, a user profession characteristic, a user contact characteristic, a user contact preference, other suitable user characteristics, or a combination thereof.

The systems and methods described herein may be configured to identify at least one attachment item based on the one or more user characteristics. The systems and methods described herein may be configured to identify at least one digital message setting corresponding to the user. The systems and methods described herein may be configured to determine whether to embed the at least one attachment item based on the at least one digital message setting.

The systems and methods described herein may be configured to, in response to a determination to embed the at least one attachment item, generate a digital message including the at least one attachment item, determine a reward corresponding to the at least one attachment item, and update a user account associated with the user based on the reward. The at least one attachment item may include at least one advertisement. The systems and methods described herein may be configured to, in response to a determination not to embed the at least one attachment item, generate a digital message without the at least one attachment item.

In some embodiments, the systems and methods described herein may be configured to incentivize the user through a small gratuity earned for each digital message that includes the attachment item. The system and methods described herein may be configured to provide an entity associated with the attachment item assurance that products associated with the attachment item are viewed on a targeted basis, as will be described. In some embodiments, the systems and methods described herein may be configured to control a number of digital messages during a predefined period that may include a particular attachment item. For example, the systems and methods described herein may restrict how often the sending user attached a first attachment item corresponding to a first product during a period. In some embodiments, the systems and methods described herein may be configured to update the user account associated with the sending user (e.g., based on the reward) in response to a determination that the receiving user has opened the digital message.

In some embodiments, the systems and methods described herein may be configured to display advertisements and/or other attachment items in a conversation area of an attachment embedding application (e.g., instead of a control area of typical solutions). The systems and methods described herein may be configured to communicate a location (e.g., associated with a sending user, a receiving user, and/or indicated in one or more digital messages) with a digital message.

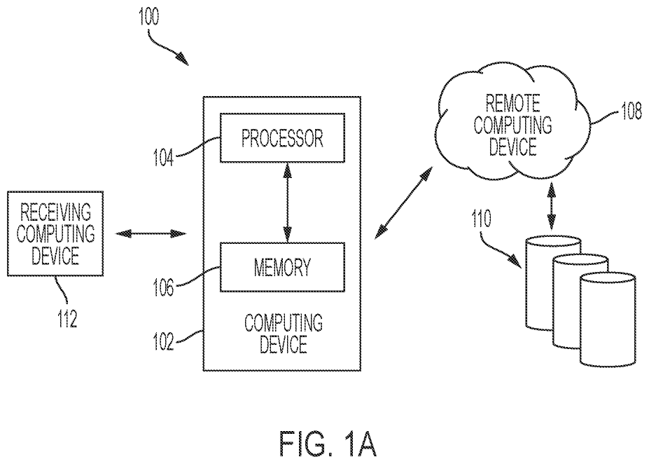

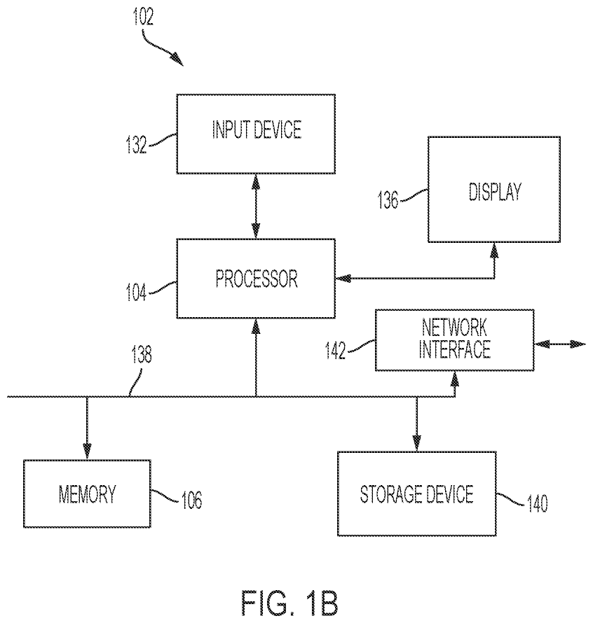

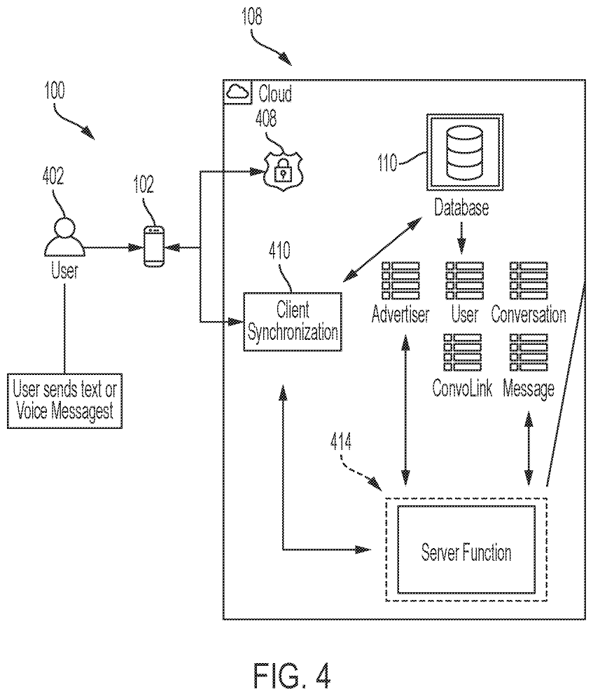

With reference to FIGS. 1A, 1B, and 4, a message delivery system 100, according to the principles of the present disclosure, is generally illustrated. The system 100 may include a sending computing device 102. The computing device 102 may be associated with a sending user 402. The computing device 102 may include any suitable computing device including a mobile computing device (e.g., a smart phone, tablet, or other suitable mobile computing device), a laptop-computing device, a desktop computing device, or any other suitable computing device. The computing device 102 may include a processor 104 and a memory 106. The processor 104 may include any suitable processor, such as those described herein. Additionally, or alternatively, the computing device 102 may include any suitable number of processors, in addition to or other than the processor 104. The memory 106 may comprise a single disk or a plurality of disks (e.g., hard drives), and includes a storage management module that manages one or more partitions within the memory 106. In some embodiments, memory 106 may include flash memory, semiconductor (solid state) memory or the like. The memory 106 may include Random Access Memory (RAM), a Read-Only Memory (ROM), or a combination thereof. The memory 106 may include instructions that, when executed by the processor 104, cause the processor 104 to, at least, perform the functions associated with the systems and methods described herein.

The computing device 102 may include a user input device 132, as is generally illustrated in FIG. 1B, that is configured to receive input from a user of the computing device 102 and to communicate signals representing the input received from the user to the processor 104. For example, the user input device 132 may include a button, keypad, dial, touch screen, audio input interface, visual/image capture input interface, input in the form of sensor data, etc.

The computing device 102 may include a display 136 that may be controlled by the processor 104 to display information to the user 402. A data bus 138 may be configured to facilitate data transfer between, at least, a storage device 140 and the processor 104. The computing device 102 may also include a network interface 142 configured to couple or connect the computing device 102 to various other computing devices or network devices via a network connection, such as a wired or wireless connection, or other suitable connection. In some embodiments, the network interface 142 includes a wireless transceiver.

The storage device 140 may comprise a single disk or a plurality of disks (e.g., hard drives), one or more solid-state drives, one or more hybrid hard drives, and the like. The storage device 140 may include a storage management module that manages one or more partitions within the storage device 140. In some embodiments, storage device 140 may include flash memory, semiconductor (solid state) memory or the like.

In some embodiments, the computing device 102 may be configured to embed one or more attachment items to a digital message. The computing device 102 may communicate with a remote computing device 108. The remote computing device 108 may include any suitable computing device or devices, such as a cloud computing device or system, a remotely located server or servers, a remotely or proximately located mobile computing device or application server that provides information to a mobile computing device, other suitable remote computing devices, or a combination thereof. The remote computing device 108 may be remotely located from the computing device 102, such as in a datacenter or other suitable location.

In some embodiments, the computing device 102 may retrieve one or more applications from the remote computing device 108. For example, the remote computing device 108 may host or provide access to an application repository. The computing device 102 may receive instructions from, for example, input provided by the user 402, to retrieve (e.g. download) an attachment embedding application from the remote computing device 108. In some embodiments, the computing device 102 may receive the instructions to retrieve the attachment embedding application from another application already disposed on the computing device 102. The computing device 102 may be configured to execute the attachment embedding application and/or any other suitable application. For example, the processor 104 may execute instructions stored on the memory 106. The instructions may cause the processor 104 to, at least initiate the attachment embedding application. The instructions may further cause the processor 104 to perform various functions, such as those described herein, of the attachment embedded application.

In some embodiments, the user 402 may be authenticated by the attachment embedding application, at least, during a first time use of the attachment embedding application by the user 402. For example, the user 402 may provide corresponding user credentials, such as a user name and password, to the attachment embedding application. The attachment embedding application may verify the user name and password using information generated during an account creation process for the user 402. At securing application 408 of the remote computing device 108 may be configured to verify and/or authenticate the user 402 using the user credentials.

In some embodiments, an application on the remote computing device 108, such as the client synchronization 410, may be configured to synchronize information corresponding to the attachment embedding application (e.g., such as user data, attachment item information, and the like), the user 402, various other users, other suitable information, or a combination thereof.

In some embodiments, the attachment embedding application may be configured to generate digital messages that include one or more attachment items. For example, the user 402 may access the attachment embedding application, via a display of the computing device 102. The user 402 may initiate a new digital message by interacting with the attachment embedding application. For example, the user 402 may input textual information using the input device 132. Additionally, or alternatively, the user 402 may provide voice commands, using the input device 132 or other suitable input device of the computing device 102. The processor 104, using the attachment embedding application, may convert the voice commands to textual information and/or the processor 104, using the attachment embedding application, may generate an audio file corresponding to at least a portion of the voice commands. The attachment embodiment application may include the textual information and/or audio file in the digital message. Additionally, or alternatively, the attachment embedding application may provide the user 402 with a plurality of attachment items for inclusion in the digital message. For example, the attachment items may include graphics, animated graphics, images, audio files, video files, emojis, other suitable attachment items, or a combination thereof. In some embodiments, the attachment items includes information and/or one or more advertisements corresponding to one or more businesses, organizations, restaurants, events (e.g., such as sporting events, performance events, and the like), and the like.

In some embodiments, the user 402 may interact with another application, such as a native messaging application or third party messaging application, on the computing device 102. The attachment embedding application may be triggered or initiated by interaction with the other application. The attachment embedding application may be configured to integrate or interact with the other application. The attachment embedding application may provide the sending user with the plurality of attachment items to be included in the digital message generated using the other application.

In some embodiments, the attachment embedding application may be configured to register the user 402 using corresponding contact information (e.g., such as a telephone number, electronic mail address, or other suitable contact number), associated with the computing device 102, with a user registration database, such as the database 110. The database 110 may include any suitable database or data storage device disposed remotely from the computing device 102. In some embodiments, the database 110 may include a plurality of databases. In some embodiments, the database 110 may be configured to provide information to the client synchronization 410, as described.

In some embodiments, during an initial setup of the attachment embedding application, the attachment embedding application may be configured to generate a user profile associated with the user 402. For example, the attachment embedding application may generate one or more user interfaces comprising various input fields. The user 402 may provide input to the attachment embedding application using the various input fields. The input may include one or more characteristics of the user 402. The one or more characteristics of the sending user may include a user name, a user age, a user gender, a user geographic location, a user deposit account (e.g., such as a saving account, a checking account, an online deposit account, a crypto currency account, and/or any other suitable account), other suitable input, or a combination thereof. The attachment embedding application, using the processor 104, may generate the user profile based on the input. The computing device 102 may store the user profile in the memory 106 or other suitable memory of the computing device, on the remote computing device 108, on the database 110, on another suitable storage location, or a combination thereof. In some embodiments, the user 402 may provide a profile image to be used with the attachment embedding application (e.g., and sent to receiving users, for example).

In some embodiments, the attachment embedding application may be configured to receive input corresponding to one or more receiving users (e.g., contacts stored on the sending device, other users associated with the user 402, or a combination thereof). For example, the attachment embedding application may receive, from the user 402, one or more characteristics of each respective receiving user. The one or more characteristics of a receiving user may include a user name, a user gender, a user age, a user geographic location, one or more user interests (e.g., home décor, music, hunting, outdoor activities, excursive, diet, culinary, real estate, financial investment, automobiles, other suitable interests of a combination thereof). The attachment embedding application, using the processor 104, may update the user profile to include the one or more characteristics for each respective receiving user. The computing device 102 may store the user profile in the memory 106 or other suitable memory of the computing device, on the remote computing device 108, on the database 110, on another suitable storage location, or a combination thereof.

In some embodiments, the attachment embedding application may identify receiving users corresponding to the user 402 and/or the computing device 102. For example, the attachment embedding application may search recent phone numbers contacted (e.g., via voice communication or digital message) on the computing device 102. The attachment embedding application, using the processor 104, may present a list of receiving users to the user 402. The user 402 may provide the receiving user characteristics for each receiving user on the list. Additionally, or alternatively, the user 402 may instruct (e.g., enable) the attachment embedding application to gather receiving users from a contact list or set of contacts on the computing device 102. The attachment embedding application, using the processor 104, may present the user 402 with the contact list or set of contacts. The user 402 may provide the receiving user characteristics for each contact on the contact list of set of contacts.

In some embodiments, the user 402 may identify groups of receiving users that share similar characteristics. The attachment embedding application, using the processor 104, may store metadata indicating that a group of receiving users share similar characteristics.

In some embodiments, the computing device 102 and/or the remote computing device 108 may be configured to extrapolate and/or predict a receiving user interests for each receiving user stored in the user profile. For example, the computing device 102 and/or the remote computing device 108 may determine a receiving user interest for a particular receiving user using an interest determination algorithm configured to compare receiving characteristics with various aspects of the attachment items. For example, the computing device 102 and/or the remote computing device 108 may identify attachment items corresponding to one or more interests of the receiving user. For example, the user 402 may indicate that the receiving user is interested in sports. The computing device 102 and/or the remote computing device 108 may identify attachment items corresponding to sporting goods, sporting events, sporting broadcasts, and the like.

In some embodiments, the user 402 may provide further levels of granularity of the receiving user interests. For example, the user 402 may indicate that the receiving user is interested in sports and in particular, baseball. The computing device 102 and/or the remote computing device 108 may identify attachment items corresponding to baseball sporting goods, baseball sporting events, baseball broadcasts, and the like. It should be understood that the characteristics corresponding to the receiving user may be tuned using any suitable granularity or information.

In some embodiments, the computing device 102 and/or the remote computing device 108 may use an artificial intelligence engine that uses at least one machine learning mechanism to identify one or more attachment items and/or attachment item/categories for the receiving user. The machine learning mechanism may include any suitable machine learning mechanism. The machine learning mechanism may be trained using any suitable technique and/or dataset. The machine learning mechanism may be configured to identify attachment items for the receiving user based on the characteristics corresponding to the receiving user. The machine learning mechanism may identify attachment items that are not obvious based on the characteristics of the receiving user. For example, the characteristics of the receiving user may indicate that the receiving user is interested in baseball, has school-aged children, and lives in a particular community. The machine learning mechanism may identify attachment items corresponding to little league baseball team registration, young baseball sporting goods, and the like.

In some embodiments, the attachment embedding application may be configured to receive one or more user settings corresponding to the user 402. For example, the user 402 may provide, via input fields corresponding to a user interface of the attachment embedding application, setting preferences corresponding to a digital message attachment frequency (e.g., how often, such as every digital message, every other digital message, every defined period for a particular receiving user, every defined period for all receiving users, to attach items to digital messages), receiving users to exclude from including attachment items when sending digital messages, an attachment item type restriction for a particular receiving user (e.g., indicating not to use certain attachment item categories or types for the particular receiving user). In some embodiments, the user 402 may provide additional settings, such as a last seen setting, a read setting, or other suitable settings. The attachment embedding application may be configured to provide feedback and/or functionality to the sending user based on the settings.

In some embodiments, the attachment embedding application may be configured to receive one or more attachment item category preferences. For example, the user 402 may provide, using input fields associated with a user interface of the attachment embedding application, one or more preferred attachment item categories (e.g., sporting goods, home décor, any other suitable category described herein, any other suitable category, or a combination thereof). The attachment embedding application, using the processor 104, may generate metadata indicating the preferred attachment item categories.

In some embodiments, the computing device 102 may receive an instruction from the user 402 to generate a digital message. For example, the user 402 may initiate the attachment embedding application by selecting the application using, for example, a touchscreen of the computing device 102. The attachment embedding application may retrieve, from the database 110 or other suitable location, the user profile associated with the user 402, the one or more settings associated with the user 402, the one or more preferred attachment item categories associated with the user 402, or a combination thereof. The user 402 may provide information (e.g., the textual information and/or voice commands) to generate the digital message, as described.

In some embodiments, in response to receiving the information, the attachment embedding application, using the processor 104, determines whether to attach an attachment item based, at least, on the user profile and the one or more settings. For example, the attachment embedding application may identify a receiving user indicated in the digital message (e.g., the user the user 402 has included in the digital message). The attachment embedding application, using the processor 104, may determine whether to attach an attachment item to the digital message based on the one or more settings. For example, the one or more settings may indicate whether to attach an attachment item for the identified receiving user and/or may identify a frequency for attaching attachment items for the identified receiving user. If the attachment embedding application determines not to attach an attachment item to the digital message based on the identified user and the one or more settings, the attachment embedding application proceed to generate and communicate the digital message to the receiving user.

Alternatively, if the attachment embedding application determines to attach an attachment item to the digital message, the attachment embedding application, using the processor 104, identifies potential attachment items to attach to the digital message. For example, the attachment embedding application, using the processor 104, identifies attachment items and/or attachment item categories based on the user profile and/or the preferred attachment categories. For example, the attachment embedding application may identify attachment items corresponding to the interests of the receiving user. The attachment embedding application may restrict the potential attachment items to the preferred attachment item categories.

In some embodiments, the attachment embedding application, using the processor 104, may identify potential attachment items based on one more keywords or characters of the information provided by the user 402 (e.g., to the digital message). For example, the attachment embedding application may be configured to identify keywords or characters of the textual information and/or voice commands and identify corresponding attachment items. For example, the user 402 may include the keyword “hungry” (e.g., or some variation thereof) in the textual information and/or voice commands. The attachment embedding application, using the processor 104, may identify attachment items corresponding to restaurants, food, other suitable attachment item categories, or a combination thereof. It should be understood that the attachment embedding application, using the processor 104, may access the attachment items and/or attachment items locally on the computing device 102, remotely on the remote computing device 108, remotely on the database 110, any other suitable location, or a combination thereof.

In some embodiments, the computing device 102 receives attachment items according to a predetermined frequency (e.g., daily, weekly, and so on), upon each initiation of the application embedding application, or any suitable time. In some embodiments, the computing device 102 may access all attachment items remotely. In some embodiments, some attachment items may be stored locally on the computing device 102 and some attachment items may be stored remotely from the computing device 102.

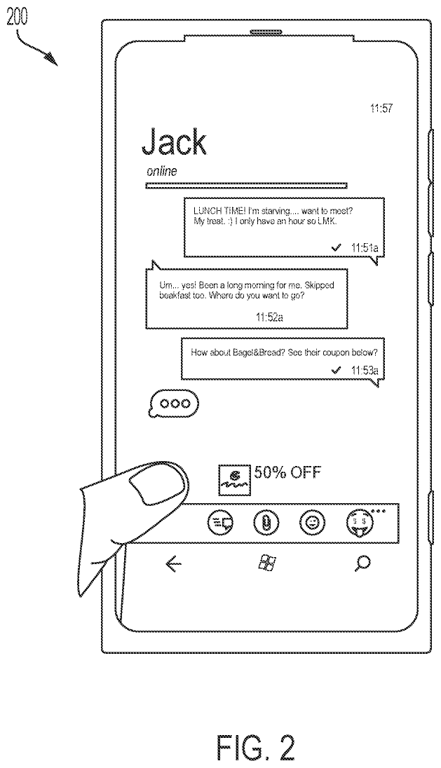

In some embodiments, the attachment embedding application, using the processor 104, may present the potential attachment items on a user interface of the attachment embedding application while the sending user is providing the textual information. As is illustrated in FIG. 2, the potential attachment items may be provided in a lower portion of the user interface. It should be understood that the potential attachment items may be provided at any suitable location of the user interface, such as in line of a conversation proceeding an associated digital message and preceding subsequent digital messages, or other suitable location. The attachment embedding application may provide one attachment item, a plurality of attachment items, a category of attachment items, a plurality of categories of attachment items, or a suitable number of attachment items. The attachment embedding application may arrange the potential attachment items on the user interface by relevance, by frequency of user, or any suitable arrangement. In some embodiments, the attachment embedding application may be configured to attach a predefined attachment item to every digital message.

The user 402 may then select one or more attachment items from the potential attachment items. The attachment embedding application, using the processor 104, may attach the selected attachment items to the digital message. The user 402 may send the digital message to the receiving user (e.g., using the remote computing device 108). In response to the user 402 sending the digital message to the receiving user, the computing device 102 may notify the remote computing device 108 or any suitable computing device that the user 402 sent a digital message including the selected attachment items. The computing device 102 may also indicate the other potential attachment items that the user 402 did not select. The remote computing device 108 or other suitable computing device may identify a reward associated with sending a digital message with the selected one or more attachment items. For example, the reward may include a monetary amount associated with each of the selected attachment items. The remote computing device 108 and/or the other suitable computing device may deposit a monetary amount corresponding to the reward in the account provided by the user 402.

In some embodiments, the attachment embedding application may be configured to operate, using the processor 104, in a ticker-tape mode. When the attachment embedding application is operating in the ticker-tape mode, the attachment embedding application may omit determining potential attachment items and may provide a scrolling list of attachment items (e.g., at random or according to a predefined list) to the user 402 via the user interface. Additionally, or alternatively, the attachment embedding application may provide the scrolling list of attachment items based on the identified potential attachment items or based on a combination of the potential attachment items and a random or predefined set of attachment items.

In some embodiments, the remote computing device 108 may select the attachment items for attachment to the digital message. For example, the remote computing device 108 may be configured to execute a server function application 114. The server function application 114 may receive a trigger (e.g., such as input, a flag being set, or other suitable trigger) indicating that a new digital message has been created. The digital message may be generated on the computing device 102 and stored in the database 110 (e.g., in a message table), or other suitable location.

The server function application 114 may identify words and/or symbols (e.g., such as emojis or other symbols) of the digital message that indicate or correspond to one or more attachment items. The server function application 114 may determine whether the words and/or symbols of the digital message indicate a location of the user 402 and/or a location of the receiving user. For example, the server function application 114 may use natural language processing to identify the location of the user 402, the location of the receiving user, key words that correspond to primary or secondary key words of a respective attachment item, or a combination thereof.

In some embodiments, the server function application 114 may be configured to detect, using the natural language processing, textual information in various languages. Additionally, or alternatively, the server function application 114 may access various tables on the database 110 to identify, using the natural language processing, the key words and/or locations of the digital message. The tables may include an advertiser table, a user table, a conversation table, a convolink table (e.g., configured to link conversations between users and/or groups), a message table, and the like. The tables may include various information corresponding to attachment items associated with various advertisers (e.g., and corresponding key words), information corresponding to the user 402 and/or the receiving user or users, information corresponding to the conversation associated with the digital message (e.g., including other digital messages sent back and forth between the user 402 and the receiving user or users), information indicating conversation links, information corresponding to the digital message, other suitable information, or a combination thereof. The remote computing device 108 may send the digital message, including attachment items corresponding to the identified key words and/or locations, to the receiving user.

In some embodiments, the server function application 114 may compare the tokens, as described, to the fields and information of the advertiser table to identify one or more advertisements and/or advertisers associated with the tokens of the digital message.

The receiving user may receive the digital message on a receiving computing device 112. The computing device 112 may include any suitable computing device and may have features similar to or different from the computing device 102. The computing device 112 may include the attachment embedding application. For example, the receiving user may download or retrieve the attachment embedding application in a manner similar to those of the computing device 102 and/or the user 402. The receiving user may open the digital message using an interface of the attachment embedding application on the computing device 112. In response to the receiving user opening the digital message, the attachment embedding application on the computing device 112 may generate a notification to the remote computing device 108, the computing device 102, or other suitable computing device indicating that the receiving user has read the digital message. The remote computing device 108 or other suitable computing device may receive, from the computing device 102 and/or the computing device 112, the indication that the receiving user has read the digital message.

The remote computing device 108 and/or the other suitable computing device may identify a reward associated with the receiving user reading the digital message including the selected attachment items. The remote computing device 108 and/or the other suitable computing device may deposit a monetary value corresponding to the reward in the account provided by the user 402. In some embodiments, the remote computing device 108 and/or the other suitable computing device may deposit the monetary value only in response to the receiving user reading the digital message. For example, the remote computing device 108 and/or the other suitable computing device may not deposit a monetary value corresponding to the reward associated with sending the digital message including the selected attachment items until the receiving user has read the digital message, at which point, the remote computing device 108 and/or the other suitable computing device may deposit both of the monetary value associated with the reward for sending the digital message and the monetary value associated with the reward for the receiving user reading the digital message. In some embodiments, the reward for the receiving user reading the digital message may include the reward for sending the digital message.

In some embodiments, the reward, or rewards may increase or decrease according to a sliding scale. For example, the rewards may increase or decrease based on a frequency of use by the user 402. Additionally, or alternatively, the rewards may increase or decrease based on any other suitable factors.

In some embodiments, the remote computing device 108 may perform data analytics on the digital message sent by the user 402. For example, the remote computing device 108 may perform data analytics corresponding to the selected attachment items and/or the attachment items not selected by the user 402. Results of the data analytics may be used to refine or tune the system 100. Additionally, or alternatively, the results of the data analytics may be used to train the machine learning mechanism.

In some embodiments, once a digital message is sent by the user 402, the database 110 may be updated with the digital message and an event is triggered to call the server function application 114 indicating that something changed in the message table of the database 110. The server function application 114 may be triggered with the event information. The event information may include one or more of message content, a message identifier, conversation participants, a location of the computing device 102 used by the user 402 to send the digital message, an author of the message, and the like.

In some embodiments, the server function application 114 may use natural language processing to analyze the text and/or audio files (e.g., after being converted to text and/or in audio form) of the digital message. The text may include emojis. If server function application 114 identifies one or more emoji in the text, the server function application 114 may translate the emojis to text to be used for identifying attachment items to embed in the digital message.

In some embodiments, the server function application 114 may tokenize the text and identify keywords that have been selected by one or more entities, as described herein. For example, each entity may select (e.g., pay for) primary keywords and/or secondary keywords. The primary keywords and/or secondary keywords may be associated with one or more attachment items. The server function application 114 may use the keywords, identified in the digital message, to identify attachment items to embed in the digital message. As used herein, the term tokenize, tokenizing, and the like may refer to segmenting text strings into single words, symbols, and/or multiple word strings.

In some embodiments, the server function application 114 may calculate a message score using the tokens (e.g., segmented words, symbols, or word strings resulting from tokenizing the digital message) from the digital message. For example, the server function application 114 may determine if any of the tokens match any primary keywords. If the server function application 114 identifies only one primary keyword match, then the attachment item associated with the primary keyword will be embedded in the digital message. Alternatively, if the server function application 114 identifies two or more primary keywords in the digital message, the server function application 114 may determine whether any tokens match any of the secondary keywords.

The server function application 114 may identify the attachment item to embed in the digital message based on the secondary keywords that match the tokens. The server function application 114 may generate a score for each attachment item indicated by the primary keywords and/or the secondary keywords. The server function application 114 may embed, in the digital message, the attachment item with the highest score. Additionally, or alternatively, the server function application 114 may generate a list of attachment items ranked by score (e.g., highest score to lowest score or other suitable arrangement). The server function application 114 may identify a predetermined number of attachment items from the list. The predetermined number may be any suitable number such as 3, 4, 5, or other suitable number. The server function application 114 may embed, in the digital message, the attachment item having the highest score and may further embed the attachment items corresponding to the predetermined number (e.g., arranged such that, when the user 402 selects the attachment item, the attachment items from the list of scored attachment items corresponding to the predetermined number may be visible to the user 402 for selection). The sender may receive the attachment item embedded in the digital message at the interface of the attachment embedding application (e.g., in the conversation window of the attachment embedding application).

In some embodiments, the server function application 114 may use a topic classification form of natural language processing to identify topics described in the digital message. The entities may select (e.g., pay for) various topics to trigger embedding corresponding attachment items.

In some embodiments, the server function application 114 may update the database 110 indicating attachment items embedded in various digital messages sent by the user 402. The server function application 114 may generate the rewards based on the updated information in the database 110.

In some embodiments, the server function application 114 may use the artificial intelligence engine, as described. The at least one machine learning model used by the artificial intelligence engine may be initially trained using data generated to indicate correlations between keywords and attachment items. Additionally, or alternatively, the at least one machine learning model may be further trained using output generated by the machine learning model. For example, the machine learning model my output a prediction indicating an attachment item that corresponds to keywords identified in the digital message. The user 402 or other use may provide feedback indicating a relevance of the attachment item embedded in the digital message. The relevance may be provided via a survey or input presented to the user 402 via the attachment embedding application. In some embodiments, the server function application 114 may determine the relevance based on text and/or audio files of subsequent digital messages. For example, the text may indicate that the user 402 liked the attachment item. The server function application 114 may, using the natural language processing, identify keywords indicating the relevance. The at least one machine learning model may be trained based on the relevance of predictions generated by the at least one machine learning model.

In some embodiments, the server function application 114 may calculate rewards in response to the user 402 interacting with the attachment item. For example, the attachment item may be presented to the user 402 via the attachment embedding application. The user 402 may select (e.g., click on, poke, or otherwise interact with) the attachment item. In response to the user 402 interacting with the attachment item, the attachment embedding application may provide further information associated with the attachment item (e.g., advertiser name, advertiser location, sale information, promotion information, and the like), and/or redirect the user 402 to a website corresponding to the attachment item. The server function application 114 may generate a reward for the user 402 based on the interaction with the attachment item. The reward may be larger or smaller than the reward generated for the user 402 receiving the attachment item, as described.

In some embodiments, the server function application 114 may be configured to receive data indicating that the user 402, using the attachment item (e.g., directly or after being redirected to the website associated with the attachment item), made a purchase, signed up for additional information, and the like. The server function application 114 may generate an additional or an alternative reward based on the data.

In some embodiments, the system 100 and/or the computing device 102 may perform the methods described herein. However, the methods described herein as performed by the system 100 and/or the computing device 102 are not meant to be limiting, and any type of software executed on a controller can perform the methods described herein without departing from the scope of this disclosure. For example, a controller, such as a processor executing software within a computing device, can perform the methods described herein.

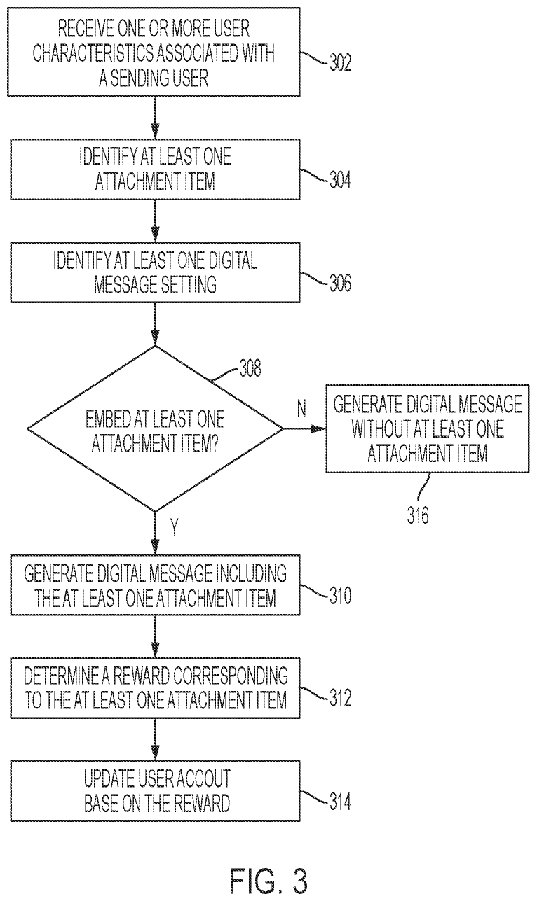

FIG. 3 is a flow diagram generally illustrating a digital message attachment method 300 according to the principles of the present disclosure. At 302, the method 300 receives one or more or user characteristics associated with a sending user. For example, the computing device 102 may receive, at the attachment embedding application, the sending user input, preferences, settings, and the like.

At 304, the method 300 identifies at least one attachment item. For example, the computing device 102 may identify one or more attachment items based on the one or more user characteristics (e.g., including receiving user characteristics, user preferences, user settings, other suitable information, or a combination thereof).

At 306, the method 300 identifies at least one digital message setting. For example, the computing device 102 identifies one or more user settings. The one or more user setting may indicate, as described, whether to attach an attachment item to the digital message.

At 308, the method 300 determines whether to embed the at least one attachment item. For example, the computing device 102 determines, based on the at least one setting, whether to embed the at least one attachment item. If the computing device 102 determines to embed the at least one attachment item, the method 300 continues at 316. If the computing device 102 determines to embed the attachment item, the method 300 continues at 310.

At 310, the method 300 generates a digital message including the at least one attachment item. For example, the computing device 102 generates, at the attachment embedding application, the digital message including the at least one attachment item. As described, the computing device 102 may provide, at the attachment embedding application, the potential attachment items. The sending user may select on or more of the potential attachment items. The computing device 102 embeds the selected attachment items.

At 312, the method 300 determines a reward corresponding to the at least one attachment item. For example, the computing device 102, the remote computing device 108, and/or the other suitable computing device may determine a reward associated with attaching the at least one attachment item to the digital message (e.g. based on sending the digital message and/or based on the receiving user reading the digital message).

At 314, the method 300 updates a user account based on the reward. For example, the computing device 102, the remote computing device 108, and/or the other suitable computing device may update the account provided by the sending user based on the reward.

At 316, the method 300 generates the digital message without the at least one attachment item. For example, the computing device 102, at the attachment embedding application, generates the digital message without embedding the at least one attachment item.

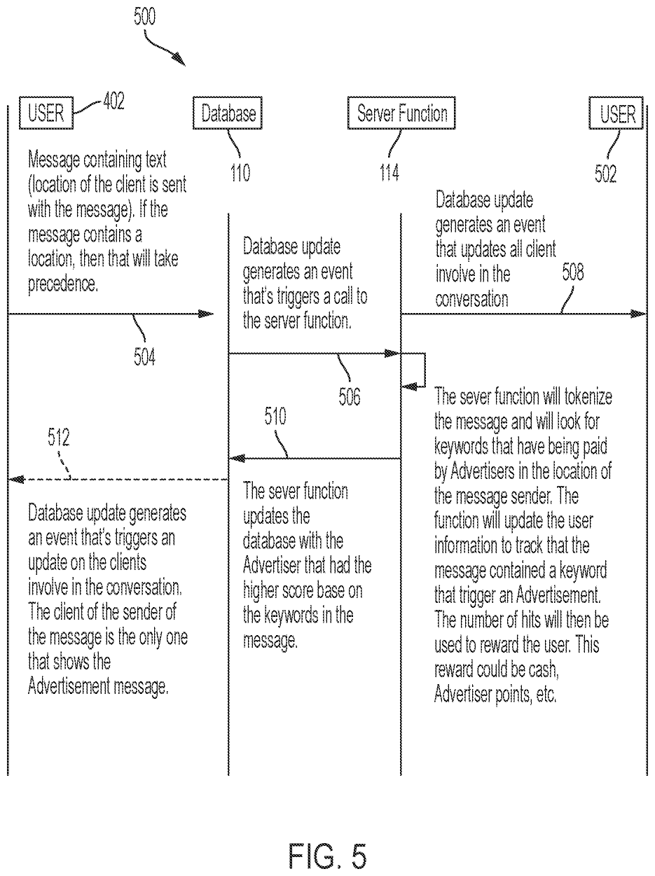

FIG. 5 is a flow diagram generally illustrating an alternative message delivery method 500 according to the principles of the present disclosure. At 504, the user 402 provides textual information and/or voice commands. The method 500 generates a digital message that includes text and/or audio files corresponding to the textual information and/or voice commands. The method 500 may provide, with the digital message, a location of the user 402. For example, the computing device 102 may provide, to the remote computing device 108, the digital message and the location of the user 402. The computing device 102 may determine the location of the user 402 using any suitable technique, such as using a global position system (GPS) of the computing device 102, or other suitable components or techniques.

The method 500 may determine whether the text and/or audio files indicates a location. For example, the remote computing device 108 may receive the digital message and the location of the user 402. The remote computing device 108 may determine whether the text and/or audio files indicate a location. If the remote computing device 108 determines that the text and/or audio files indicate a location, the remote computing device 108 may use the location indicated by the text and/or audio files to identify attachment items to embed in the digital message. Additionally, or alternatively, the remote computing device 108 may use the location indicated by the text and/or audio files and/or the location of the user 402 to identify attachment items to embed in the digital message.

At 506, the method 500 generates an event that triggers a call to a server function application. For example, the remote computing device 108 may store, in the database 110 or other suitable location, the digital message. The database 110 or other suitable location may generate an event indicating receipt of the digital message. The even may trigger a call to the server function application 114. The event may further update all computing devices involved in a conversation corresponding to the digital message.

At 508, the method 500 tokenizes the digital message. The method 500 may also identify keywords indicated by the digital message. For example, the server function application 114 may tokenize the digital message and/or identify keywords indicated by the digital message. The keywords may correspond to words or symbols that one or more entities (e.g., advertisers or other suitable entity), corresponding to the location of the user 402 and/or the location indicated by the digital message (e.g., if the remote computing device 108 determines that the digital message indicates a location), selected (e.g., by paying a keyword fee). For example, a keyword selected by a first entity may be used to identify attachment items corresponding to the first entity (e.g., the keyword may be used by the remote computing device 108 to embed an attachment item associated with the first entity into the digital message). Additionally, or alternatively, the method 500 updates user information associated with the user 402 to track that the digital message included at least one keyword that triggered the embedding of an attachment item. For example, the server function application 114 may update the user information stored in the database 110 to indicate that the digital message included at least one keyword that resulted in the attachment item being embedded by the remote computing device 108. In some embodiments, the server function application 114 may use the number of times the attachment item is triggered by a corresponding key word in a digital message sent by the user 402 to determine a reward for the user 402 (e.g., cash, points, or other suitable reward).

At 510, the method 500 may update the database 110 with information indicating an entity having a highest score based on a number of embedded attachment items corresponding to the entity. For example, the server function application 114 may access information stored in the database 110 indicating a number of embedded attachment items used in digital messages correspond to each entity. The server function application 114 may determine a score for each entity based on the embedded attachment items (e.g., as the user 402 and/or other users generate digital messages, one or more points may be added to a score for each embedded attachment item used in the digital messages that correspond to a particular entity). The server function application 114 may determine the entity with the highest score and may update the database 110 to indicate the entity with the highest score.

At 512, the method 500 may generate an event that triggers an event on all computing devices involved in the conversation associated with the digital message. For example, the server function application 114 may update the databased 110, which may generate the event at each computing device. The event may include sending the digital message to the remote computing device 112 of the receiving user 502 and/or updating the interface of the attachment embedding application on the computing device 102 (e.g., of the user 402) to display, embedded in the digital message, the attachment items selected based on the keywords and/or locations associated with the digital message.

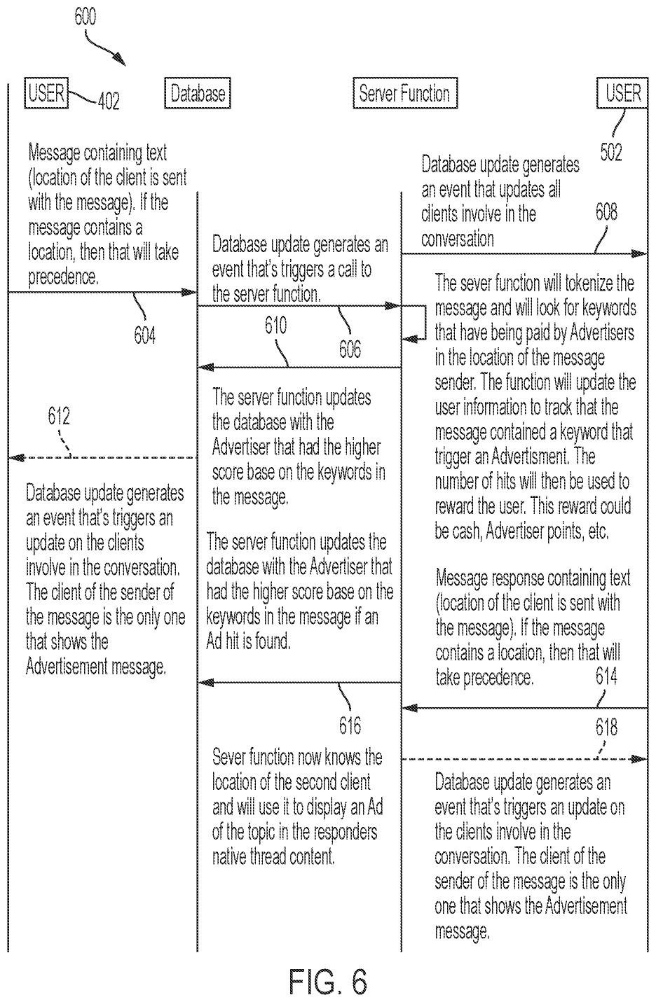

FIG. 6 is a flow diagram generally illustrating an alternative message delivery method 600 according to the principles of the present disclosure. At 604, the user 402 provides textual information and/or voice commands. The method 600 generates a digital message that includes text and/or audio files corresponding to the textual information and/or voice commands. The method 600 may provide, with the digital message, a location of the user 402. For example, the computing device 102 may provide, to the remote computing device 108, the digital message and the location of the user 402. The computing device 102 may determine the location of the user 402 using any suitable technique, such as using the GPS of the computing device 102, or other suitable components or techniques.

The method 600 may determine whether the text and/or audio files indicates a location. For example, the remote computing device 108 may receive the digital message and the location of the user 402. The remote computing device 108 may determine whether the text and/or audio files indicate a location. If the remote computing device 108 determines that the text and/or audio files indicate a location, the remote computing device 108 may use the location indicated by the text and/or audio files to identify attachment items to embed in the digital message. Additionally, or alternatively, the remote computing device 108 may use the location indicated by the text and/or audio files and/or the location of the user 402 to identify attachment items to embed in the digital message.

At 606, the method 600 generates an event that triggers a call to a server function application. For example, the remote computing device 108 may store, in the database 110 or other suitable location, the digital message. The database 110 or other suitable location may generate an event indicating receipt of the digital message. The even may trigger a call to the server function application 114. The event may further update all computing devices involved in a conversation corresponding to the digital message.

At 608, the method 600 tokenizes the digital message. The method 600 may also identify keywords indicated by the digital message. For example, the server function application 114 may tokenize the digital message and/or identify keywords indicated by the digital message. The keywords may correspond to words or symbols that one or more entities (e.g., advertisers or other suitable entity), corresponding to the location of the user 402 and/or the location indicated by the digital message (e.g., if the remote computing device 108 determines that the digital message indicates a location), selected (e.g., by paying a keyword fee). For example, a keyword selected by a first entity may be used to identify attachment items corresponding to the first entity (e.g., the keyword may be used by the remote computing device 108 to embed an attachment item associated with the first entity into the digital message). Additionally, or alternatively, the method 500 updates user information associated with the user 402 to track that the digital message included at least one keyword that triggered the embedding of an attachment item. For example, the server function application 114 may update the user information stored in the database 110 to indicate that the digital message included at least one keyword that resulted in the attachment item being embedded by the remote computing device 108. In some embodiments, the server function application 114 may use the number of times the attachment item is triggered by a corresponding key word in a digital message sent by the user 402 to determine a reward for the user 402 (e.g., cash, points, or other suitable reward).

At 610, the method 600 may update the database 110 with information indicating an entity having a highest score based on a number of embedded attachment items corresponding to the entity. For example, the server function application 114 may access information stored in the database 110 indicating a number of embedded attachment items used in digital messages correspond to each entity. The server function application 114 may determine a score for each entity based on the embedded attachment items (e.g., as the user 402 and/or other users generate digital messages, one or more points may be added to a score for each embedded attachment item used in the digital messages that correspond to a particular entity). The server function application 114 may determine the entity with the highest score and may update the database 110 to indicate the entity with the highest score.

At 612, the method 600 may generate an event that triggers an event on all computing devices involved in the conversation associated with the digital message. For example, the server function application 114 may update the databased 110, which may generate the event at each computing device. The event may include sending the digital message to the remote computing device 112 of the receiving user 502 and/or updating the interface of the attachment embedding application on the computing device 102 (e.g., of the user 402) to display, embedded in the digital message, the attachment items selected based on the keywords and/or locations associated with the digital message.

At 614, the method 600 receives a response message from the remote computing device 112 of the user 502. The response may include a digital message responding to the digital message sent by the user 402. The server function application 114 may determine a location of the receiving user 502 based on metadata associated with the response digital message. Additionally, or alternatively, the server function application 114 may identify a location indicated by the text and/or audio files of the response digital message, as described.

The server function application 114 may include the location of the receiving user 502 with the response digital message. In some embodiments, the server function application 114 may identify attachment items to embed in the response digital message based on keywords identified in the text and/or audio files of the response digital message, the location indicated by the text and/or audio files of the response digital message, and/or the location of the receiving user 502.

At 616, the method 600 updates the database 110 with the entity that had the highest score based on the keywords and/or locations in the digital message if the method 500 identifies an attachment item to embed in the response digital message. For example, the server function application 114 may identify attachment item to embed in the response digital message, as described, and may update scores corresponding to each entity based on attachment item, for each entity, embedded in the response digital message. The server function application 114 may update the entity with the highest score based on the updated scores.

At 618, the method 600 generates an event that triggers an update to the computing devices associated with the conversation corresponding to the digital message. For example, the server function application 114 may update the database 110, which may trigger the event. The computing device 112 of the receiving user 502 may display the attachment items embedded in the response digital message.

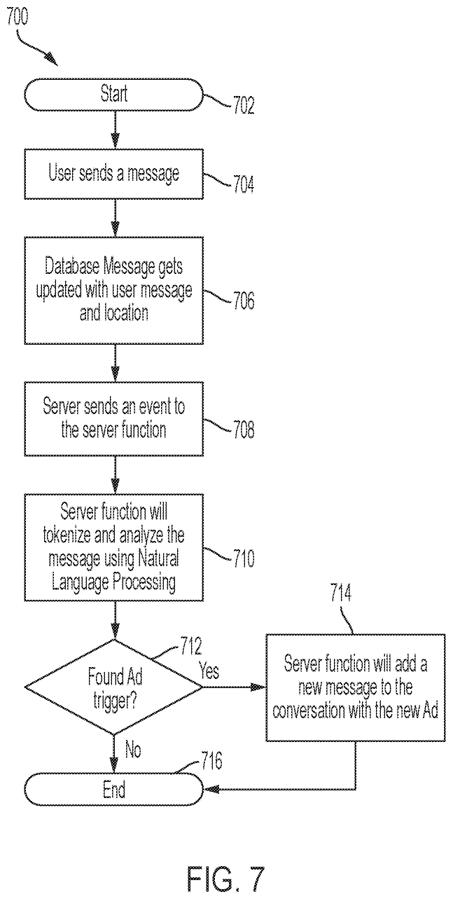

FIG. 7 is a flow diagram generally illustrating an alternative message delivery method 700 according to the principles of the present disclosure. At 702, the method 700 begins. At 704, the method 700 sends a message. For example, the user 402 may interact with the computing device 102 to send a digital message.

At 706, the method 700 updates a database based on the digital message indicating the digital message and a location of the user 402. For example, the server function application 114 may update the database 110 to indicate the digital message and a location of the user 402.

At 708, the method 700 sends an event to the server function application 114. For example, the remote computing device 108 calls the server function application 114. At 710, the method 700 tokenizes and analyzes the digital message using natural language processing. For example, the server function application 114 may tokenize the digital message. The server function application 114 may analyze the digital message using natural language processing.

At 712, the method 700 determines whether the digital message indicates any keywords. For example, the server function application 114 may identify keywords in the digital message using the natural language processing. If the server function application 114 identifies at least one keyword, the method 700 continues at 714. Alternatively, if the server function application 114 does not identify at least one keyword, the method 700 continues at 716.

At 714, the method 700 adds a new digital message including the attachment item corresponding to the at least one key word to a corresponding conversation. For example, the server function application 114 may embed the attachment item into the digital message and/or embed the attachment item into the conversation thread corresponding to the digital message.

In some embodiments, only the user 402 (e.g., the sending user) may be provided with the attachment item (e.g., only the interface used by the user 402 may be updated to include the attachment item). In some embodiments, all users involved in the conversation thread may be provided with the attachment item (e.g., interfaces for each user of the conversation thread may be updated to include the attachment item). The attachment item may be provided, by the server function application 114, in line of the conversation thread (e.g., such that the digital message is proceeded with the attachment item in line during the conversation thread) or in any other suitable position in the conversation thread. At 716, the method 700 ends.

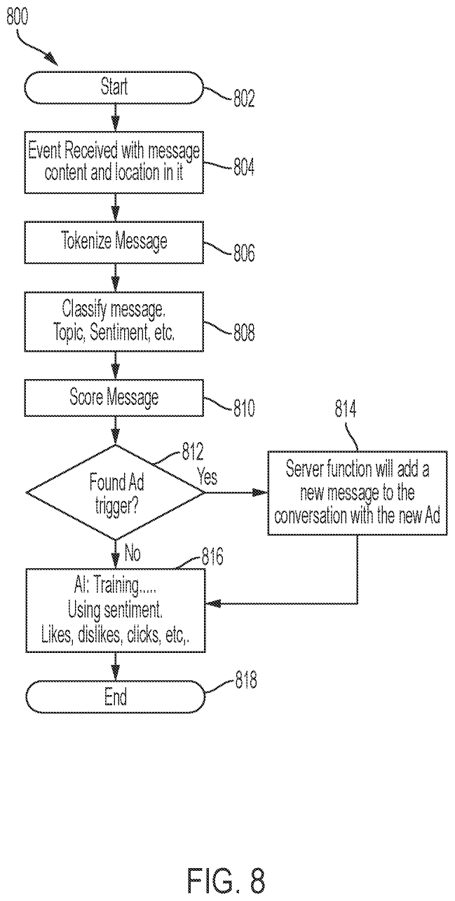

FIG. 8 is a flow diagram generally illustrating an alternative message delivery method 800 according to the principles of the present disclosure. At 802, the method 800 begins. At 804, the method 800 receives an event with message content and a location. For example, the server function application 114 may receive message content associated with the digital message and a location. The location may correspond to a location of the user 402 and/or the computing device 102 and/or a location indicated in the digital message.

At 806, the method 800 tokenizes the message. For example, the server function application 114 may tokenize the digital message. At 808, the method 800 classifies the message based on a topic, a sentiment, a keyword, a location, and the like. For example, the server function application 114 may classify the digital message based on information that includes a topic indicated by the digital message, a sentiment indicated by the digital message, a keyword of the digital message, the location of the user 492 and/or the computing device 102, the location indicated by the digital message, other suitable information, or a combination thereof.

At 810, the method 800 scores the message. For example, the server function application 114 may generate the score for the digital message.

At 812, the method 800 determines whether the digital message indicate any keywords. For example, the server function application 114 may identify keywords in the digital message using the natural language processing. If the server function application 114 identifies at least one keyword, the method 800 continues at 814. Alternatively, if the server function application 114 does not identify at least one keyword, the method 800 continues at 816.

At 814, the method 800 adds a new digital message including the attachment item corresponding to the at least one key word to a corresponding conversation. For example, the server function application 114 may embed the attachment item into the digital message and/or embed the attachment item into the conversation thread corresponding to the digital message.

In some embodiments, only the user 402 (e.g., the sending user) may be provided with the attachment item (e.g., only the interface used by the user 402 may be updated to include the attachment item). In some embodiments, all users involved in the conversation thread may be provided with the attachment item (e.g., interfaces for each user of the conversation thread may be updated to include the attachment item). The attachment item may be provided, by the server function application 114, in line of the conversation thread (e.g., such that the digital message is proceeded with the attachment item in line during the conversation thread) or in any other suitable position in the conversation thread.

At 816, the method 800 trains an artificial intelligence engine using identified sentiment, likes, dislikes, clicks, and the like. For example, the server function application 114 may train the artificial intelligence engine using sentiment corresponding to one or more subsequent digital messages, likes and/or dislikes provided by the user 402 and/or other users, and the like. At 818, the method 800 ends.

In some embodiments, a method for embedding information in a digital message includes receiving one or more user characteristics associated with a user of a corresponding computing device. The method also includes identifying at least one attachment item based on the one or more user characteristics and identifying at least one digital message setting corresponding to the user. The method also includes determining whether to embed the at least one attachment item based on the at least one digital message setting. The method also includes, in response to a determination to embed the at least one attachment item: generating a digital message including the at least one attachment item; determining a reward corresponding to the at least one attachment item; and updating a user account associated with the user based on the reward.

In some embodiments, the one or more user characteristics includes at least one of a user choice preference, a user name, a user age, a user gender, a user demography, a user profession characteristic, a user contact characteristic, and a user contact preference. In some embodiments, the method also includes, in response to a determination not to embed the at least one attachment item, generating a digital message without the at least one attachment item. In some embodiments, the at least one attachment item includes at least one advertisement.

In some embodiments, a system for embedding information in a digital message includes a processor and a memory. The memory includes instructions that, when executed by the processor, cause the processor to: receive one or more user characteristics associated with a user of a corresponding computing device; identify at least one attachment item based on the one or more user characteristics; identify at least one digital message setting corresponding to the user; determine whether to embed the at least one attachment item based on the at least one digital message setting; and, in response to a determination to embed the at least one attachment item: generate a digital message including the at least one attachment item; determine a reward corresponding to the at least one attachment item; and update a user account associated with the user based on the reward.

In some embodiments, the one or more user characteristics includes at least one of a user choice preference, a user name, a user age, a user gender, a user demography, a user profession characteristic, a user contact characteristic, and a user contact preference. In some embodiments, the instructions further cause the processor to, in response to a determination not to embed the at least one attachment item, generate a digital message without the at least one attachment item. In some embodiments, the at least one attachment item includes at least one advertisement.

In some embodiments, a method for embedding information in a digital message includes: receiving a digital message from a computing device; identifying at least one keyword associated with the digital message; identifying, using the at least one keyword, an attachment item corresponding to the at least one keyword; embedding the attachment item in a conversation thread corresponding to the digital message; and updating a table of a database to indicate the digital message and the attachment item.

In some embodiments, the method also includes, in response to embedding the attachment item: determining a reward corresponding to the attachment item; and updating a user account based on the reward. In some embodiments, embedding the attachment item in the conversation thread corresponding to the digital message includes providing, at an interface of an application executed on the computing device, the attachment item. In some embodiments, embedding the attachment item in the conversation thread corresponding to the digital message includes not providing, at an interface of an application executed on a computing device corresponding to a recipient of the digital message, the attachment item. In some embodiments, the attachment item includes at least one advertisement. In some embodiments, the method also includes generating a score for the digital message based on the attachment item. In some embodiments, the method also includes: determining a reward based on the score of the digital message; and updating a user account based on the reward. In some embodiments, identifying the at least one keyword associated with the digital message includes using natural language processing to identify the at least one keyword based on text associated with the digital message. In some embodiments, identifying the at least one keyword associated with the digital message includes using an artificial intelligence engine that uses at least one machine learning model to identify the at least one keyword based on text associated with the digital message. In some embodiments, the at least one machine learning model is trained using output of the at least one machine learning model.

In some embodiments, a system for embedding information in a digital message includes a processor and a memory that includes instructions that, when executed by the processor, cause the processor to: receive a digital message from a computing device; identify at least one keyword associated with the digital message; identify, using the at least one keyword, an attachment item corresponding to the at least one keyword; embed the attachment item in a conversation thread corresponding to the digital message; and update a table of a database to indicate the digital message and the attachment item.

In some embodiments, the instructions further cause the processor to, in response to embedding the attachment item: determine a reward corresponding to the attachment item; and update a user account based on the reward. In some embodiments, the instructions further cause the processor to embed the attachment item in the conversation thread corresponding to the digital message by providing, at an interface of an application executed on the computing device, the attachment item. In some embodiments, the instructions further cause the processor to embed the attachment item in the conversation thread corresponding to the digital message by not providing, at an interface of an application executed on a computing device corresponding to a recipient of the digital message, the attachment item. In some embodiments, the attachment item includes at least one advertisement. In some embodiments, the instructions further cause the processor to generate a score for the digital message based on the attachment item. In some embodiments, the instructions further cause the processor to: determine a reward based on the score of the digital message; and update a user account based on the reward. In some embodiments, the instructions further cause the processor to identify the at least one keyword associated with the digital message by using natural language processing to identify the at least one keyword based on text associated with the digital message. In some embodiments, the instructions further cause the processor to identify the at least one keyword associated with the digital message by using an artificial intelligence engine that uses at least one machine learning model to identify the at least one keyword based on text associated with the digital message, wherein the at least one machine learning model is trained using output of the at least one machine learning model.

In some embodiments, a computing device includes a processor; and a memory that includes instructions that, when executed by the processor, cause the processor to: receive one or more user characteristics associated with a user of a corresponding computing device; identify at least one attachment item based on the one or more user characteristics; identify at least one digital message setting corresponding to the user; determine whether to embed the at least one attachment item based on the at least one digital message setting; and, in response to a determination to embed the at least one attachment item: generate a digital message including the at least one attachment item; determine a reward corresponding to the at least one attachment item; and update a user account associated with the user based on the reward.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

What is claimed is:

1. A method for embedding information in a digital message, the method comprising:
receiving a digital message from a computing device;
identifying at least one keyword associated with the digital message;
identifying, using the at least one keyword, an attachment item corresponding to the at least one keyword;
embedding the attachment item in a conversation thread corresponding to the digital message; and
updating a table of a database to indicate the digital message and the attachment item.

2. The method of claim 1, further comprising, in response to embedding the attachment item:
determining a reward corresponding to the attachment item; and
updating a user account based on the reward.

3. The method of claim 1, wherein embedding the attachment item in the conversation thread corresponding to the digital message includes providing, at an interface of an application executed on the computing device, the attachment item.

4. The method of claim 1, wherein embedding the attachment item in the conversation thread corresponding to the digital message includes not providing, at an interface of an application executed on a computing device corresponding to a recipient of the digital message, the attachment item.

5. The method of claim 1, wherein the attachment item includes at least one advertisement.

6. The method of claim 1, further comprising generating a score for the digital message based on the attachment item.

7. The method of claim 6, further comprising:
determining a reward based on the score of the digital message; and
updating a user account based on the reward.

8. The method of claim 1, wherein identifying the at least one keyword associated with the digital message includes using natural language processing to identify the at least one keyword based on text associated with the digital message.

9. The method of claim 1, wherein identifying the at least one keyword associated with the digital message includes using an artificial intelligence engine that uses at least one machine learning model to identify the at least one keyword based on text associated with the digital message.

10. The method of claim 1, wherein the at least one machine learning model is trained using output of the at least one machine learning model.

11. A system for embedding information in a digital message, the system comprising:
a processor; and
a memory including instructions that, when executed by the processor, cause the processor to:
receive a digital message from a computing device;
identify at least one keyword associated with the digital message;
identify, using the at least one keyword, an attachment item corresponding to the at least one keyword;
embed the attachment item in a conversation thread corresponding to the digital message; and
update a table of a database to indicate the digital message and the attachment item.

12. The system of claim 11, wherein the instructions further cause the processor to, in response to embedding the attachment item:
determine a reward corresponding to the attachment item; and
update a user account based on the reward.

13. The system of claim 11, wherein the instructions further cause the processor to embed the attachment item in the conversation thread corresponding to the digital message by providing, at an interface of an application executed on the computing device, the attachment item.

14. The system of claim 11, wherein the instructions further cause the processor to embed the attachment item in the conversation thread corresponding to the digital message by not providing, at an interface of an application executed on a computing device corresponding to a recipient of the digital message, the attachment item.

15. The system of claim 11, wherein the attachment item includes at least one advertisement.

16. The system of claim 11, wherein the instructions further cause the processor to generate a score for the digital message based on the attachment item.

17. The system of claim 16, wherein the instructions further cause the processor to:
determine a reward based on the score of the digital message; and
update a user account based on the reward.

18. The system of claim 11, wherein the instructions further cause the processor to identify the at least one keyword associated with the digital message by using natural language processing to identify the at least one keyword based on text associated with the digital message.

19. The system of claim 11, wherein the instructions further cause the processor to identify the at least one keyword associated with the digital message by using an artificial intelligence engine that uses at least one machine learning model to identify the at least one keyword based on text associated with the digital message, wherein the at least one machine learning model is trained using output of the at least one machine learning model.

20. A computing device comprising:
a processor; and
a memory including instructions that, when executed by the processor, cause the processor to:
receive one or more user characteristics associated with a user of a corresponding computing device;
identify at least one attachment item based on the one or more user characteristics;
identify at least one digital message setting corresponding to the user;
determine whether to embed the at least one attachment item based on the at least one digital message setting; and
in response to a determination to embed the at least one attachment item:
generate a digital message including the at least one attachment item;
determine a reward corresponding to the at least one attachment item; and
update a user account associated with the user based on the reward.
